(19) United States
(12) Patent Application Publication
(10) Pub. No.: US 2014/0000389 A1
(43) Pub. Date: Jan. 2, 2014

(54) BIOCHEMICAL ANALYSIS CARTRIDGE AND BIOCHEMICAL ANALYSIS APPARATUS

(71) Applicant: FUJIFILM Corporation, Tokyo (JP)

(72) Inventors: Yuzuru OHTSUKA, Ashigarakami-gun (JP); Shunichi SETO, Ashigarakami-gun (JP); Hiroyuki UEDA, Ashigarakami-gun (JP)

(73) Assignee: FUJIFILM Corporation, Tokyo (JP)

(21) Appl. No.: 14/020,257

(22) Filed: Sep. 6, 2013

Related U.S. Application Data
(63) Continuation of application No. PCT/JP2012/001515, filed on Mar. 6, 2012.

(30) Foreign Application Priority Data
Mar. 8, 2011 (JP) 2011-050273

(51) Int. Cl. B01L 3/00; G01N 35/00

(52) U.S. Cl. CPC B01L 3/54; G01N 35/00584
USPC 73/863.01

(57) ABSTRACT

A biochemical analysis cartridge stores a plurality of dry analysis elements corresponding to a plurality of measurement items necessary for measurement of samples and supplies the dry analysis elements to a biochemical analysis apparatus. The biochemical analysis cartridge is equipped with a memory element that stores calibration curve data for all dry analysis elements which are within their effective lifetimes at the time of manufacture or shipment of the biochemical analysis cartridge.

### TECHNICAL FIELD

The present invention is related to a biochemical analysis apparatus for determining the concentrations of predetermined biochemical substances and ionic activity in sample liquids such as blood, urine or the like, employing a colorimetric dry analysis element or an electrolytic dry analysis element, on which the sample liquids are spotted by a spotting nozzle unit. The present invention is also related to a biochemical analysis cartridge that stores and mounts dry analysis elements.

### BACKGROUND ART

Conventionally, colorimetric dry analysis elements, by which a specific chemical component or a solid component contained in a sample can be quantitatively analyzed and the ionic activity of specific ions included in the sample by only spotting a droplet of the sample thereon, have been developed and put to practical use. Biochemical analysis apparatuses that use such dry analysis elements are capable of analyzing samples simply and expediently, and are favorably employed at medical facilities, research facilities, and the like.

The colorimetric measurement method that utilizes a calorimetric dry analysis element spots a sample onto the dry analysis element. Then, the element and is held at a constant temperature for a predetermined time in an incubator so that a color reaction (pigment generating reaction) occurs, and the optical density of the color formed by the color reaction is optically measured. That is, measuring light containing a wavelength, which is pre-selected according to the combination of the component to be analyzed and a reagent contained in the dry analysis element, is projected onto the dry analysis element and the optical density of the dry analysis element is measured. Then the concentration of the component to be analyzed is determined on the basis of the optical density using a calibration curve that represents the correspondent relationship between the concentration of the biochemical component and the optical density.

Meanwhile, the electrical potential difference measurement method that utilizes the electrolytic dry analysis element quantitatively analyzes ionic activity of specific ions contained in a sample which is spotted onto a pair of dry ion selecting electrodes by potentiometry.

In both of the aforementioned methods, a liquid sample is contained in a sample container (a blood correcting tube, etc.), which is set in an apparatus. In addition, a dry analysis element necessary for measurement is supplied to the apparatus. A spotting nozzle unit having a spotting nozzle capable of movement in a predetermined direction from the sample container is utilized to suction the sample and to spot the sample onto the dry analysis element, which is conveyed to a spotting position. Various methods for mounting the sample, the dry analysis element, as well as expendables necessary for measurement, such as nozzle tips, mixing cups for diluting liquids, diluent containers, and reference solution containers, have been proposed.

The calibration curves of the aforementioned dry analysis elements that represent the correspondent relationship between the concentration of biochemical components and optical densities greatly differ even if they are dry analysis elements of the same type, due to differences in production environments, such as temperature, humidity, and the apparatus that produced the dry analysis elements. Calibration curves for dry analysis elements are derived for predetermined production units, such as production lot units, in which a constant production environment is maintained. In measurements employing dry analysis elements, it is necessary to obtain measurement results which are corrected by unique calibration curve data corresponding to each dry analysis element, based on identifying information such as the lot numbers of the dry analysis elements. The calibration curve data are generally input to biochemical analysis apparatuses via recording media such as CD-ROM'S.

In addition, dry analysis elements individually have predetermined effective lifetimes. For this reason, it is necessary to periodically update calibration curve data of newly produced dry analysis elements, which is a burden on users.

For this reason, a method has been proposed in U.S. Pat. No. 7,887,750, in which bar codes and microchips that have unique identifiers corresponding to test portions are provided on a biochemical analysis cartridge having a plurality of examination portions that perform a plurality of different examinations on a single sample on a single flat surface. In this method, a biochemical analysis apparatus reads out the unique identifiers, and utilizes calibration curve data specified by the read out identifiers for examinations at each of the examination portions.

### DISCLOSURE OF THE INVENTION

However, in the method disclosed in U.S. Pat. No. 7,887,750, calibration curve data to be stored differs for each biochemical analysis cartridge 7. Therefore, it is necessary to determine which calibration curve data are to be stored in the memory elements provided on biochemical analysis cartridges for each biochemical analysis cartridge. Specifying the calibration curve data to be stored in the memory elements is troublesome, and there is a possibility that errors will occur in judgments regarding calibration curve data to be stored in the memory elements due to human error and the like.

The present invention has been developed in view of the foregoing circumstances. It is an object of the present invention to provide a biochemical analysis cartridge in which specification of calibration curve data to be stored in memory elements provided on the biochemical analysis cartridge is facilitated. In addition, it is another object of the present invention to provide a biochemical analysis apparatus that utilizes the biochemical analysis cartridge.

A biochemical analysis cartridge houses a plurality of dry analysis elements corresponding to a plurality of measurement items necessary to measure a sample and supplies the dry analysis elements to a biochemical analysis apparatus, and comprises a memory element that stores calibration curve data for all dry analysis elements which are within their effective lifetimes at the time of manufacture or shipment of the biochemical analysis cartridge.

Here, the expression “calibration curve data for all dry analysis elements which are within their effective lifetimes at the time of manufacture or shipment of the biochemical analysis cartridge” may include at least all of the calibration curve data for dry analysis elements that may be loaded into the biochemical analysis cartridge. For example, if the biochemical analysis cartridge is dedicated to a specific apparatus that examines blood for predetermined target substances, at least calibration curve data related to items which are examined by the specific apparatus for all of the dry analysis elements that may be loaded into the biochemical analysis cartridge 9, which are within their effective lifetimes at the time of manufacture or shipment of the biochemical analysis cartridge, may be included.

In addition, the “time of manufacture” of the biochemical analysis cartridge may be any arbitrary point in time during the production steps of the biochemical analysis cartridge. For example, the time of manufacture may be a point in time at which the memory element is mounted onto the main body of the biochemical analysis cartridge. In this case, storing the latest calibration curve data and effective lifetimes immediately prior to or immediately following mounting of the memory element onto the main body of the biochemical analysis cartridge may be considered. In addition, the “time of . . . shipment” of the biochemical analysis cartridge may be any arbitrary point in time during the shipping steps of the biochemical analysis cartridge. For example, the time of shipment may be a point in time when a manufacturer or a distributor ships the assembled biochemical analysis cartridge to a user. In this case, storing the latest calibration curve data and effective lifetimes in the memory element, which is mounted on the biochemical analysis cartridge, after receiving an order from the user and immediately prior to the distributor shipping the biochemical analysis cartridge may be considered.

It is preferable for the memory element of the biochemical analysis cartridge of the present invention to be provided at a position at which the biochemical analysis apparatus is capable of reading out data therefrom.

The “position at which the biochemical analysis apparatus is capable of reading out data therefrom” may be any position, as long as it is a position at which a readout section of the biochemical analysis apparatus can read out data from the memory element. For example, it is preferable for the memory element of the biochemical analysis cartridge to be provided such that it is positioned at a readout position of the readout section of the biochemical analysis apparatus when the biochemical analysis cartridge is loaded into the biochemical analysis apparatus. In addition, the memory element may be provided at any desired position of the biochemical analysis cartridge, such as the side surface, the bottom surface, and the upper surface thereof, as long as it is a position at which the readout section of the biochemical analysis apparatus can read out data therefrom. Further, the memory element may be provided on the outer periphery of the biochemical analysis cartridge, or within the interior thereof.

A biochemical analysis apparatus of the present invention comprises:

a calibration curve data readout section that reads out calibration curve data stored in the memory element of the biochemical cartridge of the present invention;

an identifying data readout section that reads out identifying data of the dry analysis elements loaded in the biochemical analysis cartridge; and

a warning section that issues a warning in the case that the calibration curve data specified by the identifying data read out by the identifying data readout section is not within an effective period, based on the calibration curve data read out by the calibration curve data readout section.

The warning issued by the warning section may be any type of warning as it can be recognized by a user. For example, the warning may be an audio warning. Alternatively, a visual warning may be displayed on an operating screen of the apparatus that utilizes the biochemical analysis cartridge, or displayed on a display of a computer connected to the apparatus that utilizes the biochemical analysis cartridge.

The biochemical analysis cartridge of the present invention houses a plurality of dry analysis elements corresponding to a plurality of measurement items necessary to measure a sample and supplies the dry analysis elements to a biochemical analysis apparatus, and comprises a memory element that stores calibration curve data for all dry analysis elements which are within their effective lifetimes at the time of manufacture or shipment of the biochemical analysis cartridge. Therefore, the calibration curve data to be stored in the memory element provided on the biochemical analysis cartridge can be easily specified. In addition, calibration data for all dry analysis elements which are within their effective lifetimes at the time of manufacture or shipment of the biochemical analysis cartridge can be supplied to the biochemical analysis apparatus. Therefore, necessary calibration curve data can be easily and positively supplied. As a result, the burden on users is lessened, and the efficiency of measurement operations can be improved.

A configuration may be adopted, wherein the memory element of the biochemical analysis cartridge of the present invention is provided at a position at which the biochemical analysis apparatus is capable of reading out data therefrom. In this case, the calibration curve data stored in the memory element can be read out by the biochemical analysis apparatus by placing the calibration curve data readout section of the biochemical analysis apparatus at a position into which the biochemical analysis cartridge is loaded. The need to update the calibration curve data in a separate process is obviated, and the calibration curve data are easily and positively updated by the biochemical analysis apparatus.

The biochemical analysis apparatus of the present invention comprises the calibration curve data readout section that reads out calibration curve data stored in the memory element of the biochemical cartridge of the present invention; the identifying data readout section that reads out identifying data of the dry analysis elements loaded in the biochemical analysis cartridge; and the warning section that issues a warning in the case that the calibration curve data specified by the identifying data read out by the identifying data readout section is not within an effective period, based on the calibration curve data read out by the calibration curve data readout section. Therefore, users can be notified of erroneous use of dry analysis elements of which the effective lifetimes have elapsed, and accurate lifetime management of dry analysis elements can be assisted.

### BRIEF DESCRIPTION OF THE DRAWINGS

FIG. 1 is a schematic perspective view that illustrates the configuration of a biochemical analysis apparatus in which a biochemical analysis cartridge according to an embodiment of the present invention is loaded.

FIG. 2 is a schematic plan view of the main mechanisms of the biochemical analysis apparatus.

FIG. 3 is a perspective view of the biochemical analysis cartridge.

### BEST MODE FOR CARRYING OUT THE INVENTION

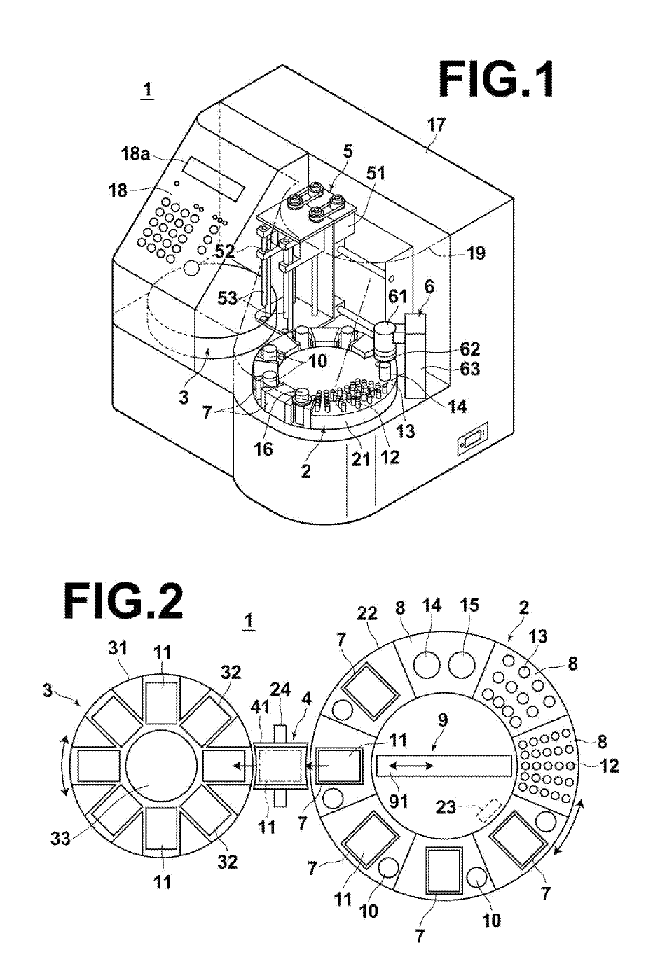

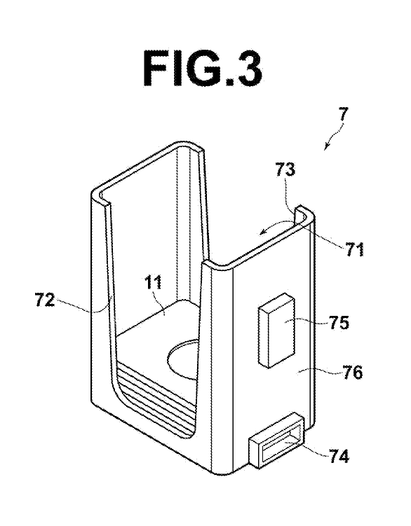

Hereinafter, an embodiment of the present invention will be described with reference to the attached drawings. FIG. 1 is a schematic perspective view that illustrates the configuration of a biochemical analysis apparatus 1 in which a biochemical analysis cartridge according to an embodiment of the present invention is loaded. FIG. 2 is a schematic plan view of the main mechanisms of the biochemical analysis apparatus. FIG. 3 is a perspective view of the biochemical analysis cartridge.

The biochemical analysis apparatus 1 illustrated in FIG. 1 has an apparatus main body 17, a circular sample tray 2, a circular incubator 3, a spotting section 4 (not shown in FIG. 1; refer to FIG. 2), and a spotting nozzle unit 5. The sample tray 2 is provided at one side (the right side in FIG. 1) of the front portion of the apparatus main body 17, and the incubator 3 is provided at the other side (the left side in FIG. 1) of the front portion of the apparatus main body 17. The spotting section 4 is provided between the sample tray 2 and the incubator 3. The spotting nozzle unit 5 is provided at the upper front portion of the apparatus main body 17 and is capable of moving in the horizontal direction. In addition, a blood filtering unit 6 that separates plasma from blood is provided in the vicinity of the sample tray 2.

The biochemical analysis apparatus 1 is also equipped with: a calibration curve data readout section 23 that reads out calibration curve data stored in a memory element of a biochemical analysis cartridge; an identifying data readout section that reads out identifying data of dry analysis elements loaded into the cartridge; and a warning means 25 that issues a warning in the case that the calibration curve data specified by the obtained identifying data is not present in the read out calibration curve data. Note that the sample tray 2, the incubator 3, the spotting section 4, the spotting nozzle unit 5, the calibration data readout section 23, and the identifying data readout section 24 are controlled by a control means (not shown) provided in the interior of the apparatus main body 17. The control means also functions as the warning means 25.

The sample tray 2 has a discoid rotary base 21 which is driven to rotate in the clockwise and counterclockwise directions. Five biochemical analysis cartridges 7 are loaded in arcuate recessed portions, which are of the same size and are radially formed from the center of the rotary base 21 at the outer circumferential portion of the rotary base 21. The five loaded biochemical analysis cartridges 7 are arranged in an arcuate manner.

The sample tray 2 having the format illustrated in FIG. 2 has an annular (donut shaped) rotary base 22 which is driven in the clockwise and counterclockwise directions. Five biochemical analysis cartridges 7 and three expendable goods cartridges 8 are loaded at eight equally divided radial portions of the rotary base 22. The annular shape is formed by loading all of the cartridges 7 and 8. The biochemical analysis cartridges 7 and the expendable goods cartridges 8 are of the same shape in plan view, and are removably attachable individually. Each of five biochemical analysis cartridges 7 has an element housing chamber 71 for holding unused dry analysis elements 11 which are necessary for each of a plurality of measurement items (FIG. 2 illustrates a state in which the dry analysis elements 11 are loaded therein). One of the three expendable goods cartridges 8 holds a plurality of nozzle tips 12, another holds a plurality of mixing cups 13, and the remaining one holds a diluent container 14 and a reference solution container 15. Holding recesses corresponding to the items to be held are formed in each of the expendable goods cartridges 8.

A plurality of combinations of samples and dry analysis elements 11, each constituted by a single sample container 10 and unused dry analysis elements 11, which are necessary to measure the samples, and expendable goods that include the nozzle tips 12, the mixing cups 13, the reference solution container 15 and the diluent container 14, are loaded onto the sample tray 2 by loading the biochemical analysis cartridges 7 and the expendable goods cartridges 8.

The rotary bases 21 and 22 of the sample tray 2 are driven to rotate in the clockwise direction or the counterclockwise direction by a rotary drive mechanism (not shown) to an operating position of the spotting nozzle unit 5. Predetermined operations to spot a sample, which includes taking out necessary nozzle tips 12, suctioning necessary samples, diluents, or reference solutions, and mixing if necessary, are performed by controlling the rotational position of the rotary bases 21 and 22 and the position of the spotting nozzle unit 5.

The sample tray 2 is equipped with a conveying means 9 (refer to FIG. 2) that conveys the dry analysis elements 11 at the central portion thereof. The conveying means 9 has an element conveying member 91 (insertion lever) which is provided to be slidably movable in the radial direction of the sample tray 2. Controlling the forward movement of the element conveying member 91 causes a dry analysis element 11 to be pressed by the leading end thereof, to automatically take the dry analysis element 11 out of the cartridge 7, to convey the dry analysis element 11 to the spotting section 4, to convey the spotted dry analysis element 11 to the incubator 3, and to covey the dry analysis element 11 after measurement is performed thereon to the center of the incubator 3, where it is discarded. The biochemical analysis cartridges 7 can be sequentially caused to stop at a position corresponding to the spotting section 4, and necessary dry analysis elements 11 can be taken out of the biochemical analysis cartridges 7, by controlling the rotational position of the rotary bases 21 and 22.

The biochemical analysis cartridge 7 of the present embodiment will be described with reference to FIG. 3. The biochemical analysis cartridge 7 houses a plurality of dry analysis elements 11 corresponding to a plurality of measurement items necessary to measure a sample and supplies the dry analysis elements 11 to the biochemical analysis apparatus 1, and is equipped with a memory element 75 that stores calibration curve data for all dry analysis elements which are within their effective lifetimes at the time of manufacture or shipment of the biochemical analysis cartridge 7. Here, all dry analysis elements which are within their effective lifetimes at the time of manufacture or shipment of the biochemical analysis cartridge are not limited to dry analysis elements that exist at the time of manufacture or shipment of the biochemical analysis cartridge, and may include dry analysis elements which are scheduled to be sold commercially in the future.

As illustrated in FIG. 3, the biochemical analysis cartridge 7 houses the plurality of dry analysis elements 11 which are necessary for measurements and loads them into the biochemical analysis apparatus 1. The biochemical analysis cartridge 7 has the element storage chamber 71, an element exit opening (not shown) at the front side of the lower end of the element housing chamber 71, and a guide hole 74, into which a conveying bar (not shown) is to be inserted. When the conveying bar is inserted into the guide hole 74, the lowermost dry analysis element 11 is conveyed out of the biochemical analysis cartridge 7 by being pressed out of the element exit opening at the front side thereof.

In addition, the upper end of the element housing chamber 71 is open and is a loading opening for dry analysis elements. Cutouts 72 and 73 that extend downward from the upper edge of the loading opening are formed in the element housing chamber 71. The dry analysis elements 11 are loaded into the element housing chamber 71 by holding the two sides of the dry analysis elements 11 and lowering them into the bottom of the element housing chamber 71.

The memory element 75 of the biochemical analysis cartridge 7 is provided at a position at which the biochemical analysis apparatus can read out data therefrom. Specifically, the memory element 75 is provided at the center of the rear side surface 76 of the biochemical analysis cartridge 7, which is positioned at a readout position of the readout section of the biochemical analysis apparatus when the biochemical analysis cartridge is loaded into the biochemical analysis apparatus.

Note that the memory element 75 may be provided at any position of the biochemical analysis cartridge 7 as long as it is at a position at which the readout section of the biochemical analysis apparatus can read out data therefrom. In addition, the memory element 75 may be provided at any desired position of the biochemical analysis cartridge 7, such as the side surface, the bottom surface, and the upper surface thereof, as long as it is a position at which the readout section of the biochemical analysis apparatus can read out data therefrom. Further, the memory element 75 may be provided on the outer periphery of the biochemical analysis cartridge 7, or within the interior thereof.

There is a possibility that an arbitrary combination of dry analysis elements corresponding to approximately 30 examination items will be set in the biochemical analysis cartridge 7 of the present embodiment. In addition, the memory element 75 has stored therein various types of data, such as calibration curve orders and calibration curve coefficients that specify calibration curves, conversion coefficients that specify conversion formulas that convert calibration curves as necessary, correction coefficients that specify correction formulas, smoothing orders that specify smoothing processes, the names of examination items, examination item codes, the types of samples, measuring wavelengths, spotting amounts, measurement times, data processing methods, numbers of digits to be displayed, and display units. The various types of data stored in the memory element 75 are correlated to each other.

In the present embodiment, at least one RFID tag is employed as the memory element 75. The biochemical analysis apparatus 1 has at least one RFID reader 23 (calibration curve data readout section 23) provided at a position that faces the position at which the memory element 75 is provided when the biochemical analysis cartridge 7 is loaded into the biochemical analysis apparatus 1. The RFID tag may be a read only tag or a read/write tag.

Various types of memory elements having sufficient capacity to store calibration curve data for all dry analysis elements which are within their effective lifetimes at the time of manufacture or shipment of the biochemical analysis cartridge 7 may be applied as the memory element 75. In addition, sufficient capacity may be realized by combining a plurality of the same or different types of memory elements to constitute the memory element 75.

Note that in the dry analysis elements of the present embodiment, approximately 10 bytes are necessary to record a lot number and 10 to 100 bytes are necessary to record calibration curve data, as identifying data that specifies each dry analysis element. The effective lifetime of dry analysis elements is often within a range from three to six months. Therefore, it is preferable for the capacity of the memory element 75 to be 5 kB or greater, more preferably 10 kB or greater, and still more preferably 20 kB or greater, in order to store calibration curve data for all dry analysis elements which are within their effective lifetimes at the time of manufacture or shipment of the biochemical analysis cartridge 7. In addition, it is preferable for the memory element to be of a non contact readout type, from which the calibration curve data readout section 23 can read out calibration curve data in a non contact manner, because the calibration curve data can be easily read out during conveyance operations by the biochemical analysis apparatus.

Here, the characteristic feature of the present invention is that the memory element 75 stores calibration curve data for all dry analysis elements “which are within their effective lifetimes at the time of manufacture or shipment of the biochemical analysis cartridge 7”. This is because manufacturers of dry analysis elements continuously manufacture new dry analysis elements, and calibration curve data are measured for the new dry analysis element. Therefore, it is preferable for the calibration curve data regarding the dry analysis elements to include calibration curve data for dry analysis elements which have been manufactured as close as possible to the time of manufacture of the biochemical analysis cartridge 7. In addition, the memory element 75 has stored therein calibration curve data for “all” dry analysis elements which are within their effective lifetimes at the time of manufacture or shipment of the biochemical analysis cartridge 7. In the case that calibration curve data for only dry analysis elements which are actually set in the biochemical analysis cartridge are stored in the memory element 75, the calibration curve data to be stored will differ for each biochemical analysis cartridge 7. For this reason, specifying the calibration curve data to be stored in the memory elements will become troublesome, and there is a possibility that errors will occur in judgments regarding calibration curve data to be stored in the memory element 75 due to human error and the like. In contrast, the determination of calibration curve data to be stored in the element 75 is facilitated, because specifying the data to be stored in the memory element 75 becomes simple, by storing calibration curve data for “all” dry analysis elements which are within their effective lifetimes at the time of manufacture or shipment of the biochemical analysis cartridge 7.

In addition, the memory element 75 of the present embodiment is that in which the latest calibration curve data is stored or updated at the time of shipment of the biochemical analysis cartridge 7. Specifically, a distributor of the biochemical analysis cartridge 7 stores or updates the latest calibration curve data in the memory element of the biochemical analysis cartridge 7 having the memory element 75 mounted on the element housing chamber 71, after receiving an order from a user, then packages and ships the biochemical analysis cartridge 7.

Here, the expression “calibration curve data for all dry analysis elements which are within their effective lifetimes at the time of manufacture or shipment of the biochemical analysis cartridge 7” may include at least all of the calibration curve data for dry analysis elements that may be loaded into the biochemical analysis cartridge. For example, if the biochemical analysis cartridge is dedicated to a specific apparatus that examines blood for predetermined target substances, at least calibration curve data related to items which are examined by the specific apparatus for all of the dry analysis elements that may be loaded into the biochemical analysis cartridge 7, which are within their effective lifetimes at the time of manufacture or shipment of the biochemical analysis cartridge, may be included.

In addition, the “time of manufacture” of the biochemical analysis cartridge may be any arbitrary point in time during the production steps of the biochemical analysis cartridge. For example, the time of manufacture may be a point in time at which the memory element is mounted onto the main body of the biochemical analysis cartridge. In this case, storing the latest calibration curve data and effective lifetimes immediately prior to or immediately following mounting of the memory element onto the main body of the biochemical analysis cartridge may be considered. In addition, the “time of . . . shipment” of the biochemical analysis cartridge may be any arbitrary point in time during the shipping steps of the biochemical analysis cartridge. For example, the time of shipment may be a point in time when a manufacturer or a distributor ships the assembled biochemical analysis cartridge to a user. In this case, storing the latest calibration curve data and effective lifetimes in the memory element, which is mounted on the biochemical analysis cartridge, after receiving an order from the user and immediately prior to the distributor packaging and shipping the biochemical analysis cartridge may be considered.

The biochemical analysis cartridges 7 described above may be loaded onto the rotary bases 21 and 22 as desired, and exchanging biochemical analysis cartridges 7 prior to measurements is also possible. Note that identifying members are provided on the biochemical analysis cartridges 7. Loading of the biochemical analysis cartridges 7 onto the sample tray 2 is detected, and sample ID's, whether filtration is necessary, etc., are identified. In addition, when the remaining amounts of expendable goods housed in the expendable goods cartridges 8 illustrated in FIG. 2, which are of the same shape as the biochemical analysis cartridges 7, become low, such expendable goods cartridges 8 may be replaced with new expendable goods cartridges 8 loaded with nozzle tips 12 and mixing cups 13 in advance.

Here, the dry analysis elements 11 which are loaded into the biochemical analysis cartridge 7 will be described. A. colorimetric dry analysis element 11 which is utilized to measure the degree of color of a sample comprises a square mount in which a reagent layer is provided. A spotting aperture is formed on the surface of the mount, and the sample is spotted through the spotting aperture. An electrolytic dry analysis element 11 which is utilized to measure the ion activity of a sample has two liquid supply apertures formed therein. The sample is spotted through one liquid supply aperture, and a reference solution, of which the ion activity is known, is spotted through the other liquid supply aperture. In addition, three pairs of ion selective electrodes, which are electrically connected to an electrical potential measuring probe of an electrical potential difference measuring means, are also provided in the electrolytic dry analysis element 11. Bar codes (not shown), in which information that specifies items of examination is recorded, are provided on the undersides of the dry analysis elements 11 as identifiers.

The spotting section 4 (FIG. 2) spots samples such as plasma, whole blood, blood serum, and urine onto the dry analysis elements 11. The spotting nozzle unit 5 spots samples onto the colorimetric dry analysis elements 11, and spots samples and reference solutions onto the electrolytic dry analysis elements 11.

The spotting section 4 includes a mounting base 41 that receives the bottom surfaces of the dry analysis elements 11, and an element holder (not shown) having an upper spotting opening. The dry analysis elements 11 move between the two components of the spotting section 4. A bar code reader 24 (identifying data readout section) for reading out the bar codes provided on the dry analysis elements 11 is provided at a forward portion of the spotting section 4. The bar code reader 24 is provided to specify examination items in order to control spotting and measurement operations to follow, as well as to detect conveyance directions (forward and backward, upper and lower surfaces) of the dry analysis elements 11.

The spotting nozzle unit 5 (FIG. 1) performs sampling of samples. The spotting nozzle unit 5 has a horizontally moving block 51 that moves horizontally, vertically moving blocks 52 and 52 that move vertically provided on the horizontally moving block 51, and two spotting nozzles 53 and 53, which are respectively fixed on the two vertically moving blocks 52 and 52. The movements of the horizontally moving block 51 and the two vertically moving blocks 52 and 52 are controlled by a drive means (not shown). The two spotting nozzles 53 and 53 move integrally in the horizontal direction and move independently in the vertical direction. For example, one of the spotting nozzles 53 is for samples, and the other spotting nozzle 53 is for the diluent and the reference solution.

The spotting nozzles 53 and 53 are formed into rod shapes having air channels that extend in the axial direction in the interiors thereof, and pipette shaped nozzle tips 12 fitted at the lower ends thereof in a sealed state. The spotting nozzles 53 and 53 are connected to air tubes which are connected to syringe pumps or the like (not shown) that supply suctioning and discharging pressure thereto. Used nozzle tips 12 are removed at a tip removing section, dropped, and discarded.

The incubator 3 is provided at a position extending from the spotting section 4. As illustrated in FIG. 2, the incubator 3 comprises a discoid rotary member 31 which is driven by a rotary drive mechanism (not shown), an upper member (not shown) provided on the rotary member 31, and a plurality of element chambers 32 for housing the dry analysis elements 11 provided at predetermined intervals along the circumference of the rotary member 31. The heights of the bottom surfaces of the element chambers 32 are the same as the height of a conveying surface of the spotting section 4. Dry analysis elements 11 which are inserted from the spotting section 4 are incubated (maintained at a constant temperature) at a predetermined temperature within the element chambers 32 by a heating means provided in the upper member.

In addition, the inner aperture of the rotarymember 31 is formed as a discarding opening 33. When dry analysis elements 11 within the element chambers 32 are moved toward the center after measurements, they drop into the discarding opening 33 and are discarded. Note that a cover is provided on the upper surface of the incubator 3, and a collecting box that collects the dry analysis elements after measurements is provided under the discarding opening 33.

The incubator 3 is equipped with measuring means (not shown) that perform measurements of the dry analysis elements 11. The colorimetric dry analysis elements 11 and the electrolytic dry analysis elements 11 are conveyed to the incubator 3. Therefore, measuring means (light measuring means and electrical potential difference measuring means) capable of performing measurements of both types of dry analysis elements 11 are provided. Note that a second incubator equipped with an electrical potential difference measuring means may be provided toward the side of the spotting section 4. In this case, the electrolytic dry analysis elements 11 are separately conveyed to the second incubator, and electrical potential differences may be measured therein.

In the case of the colorimetric measuring method, an opening for measuring light is formed in the center of the bottom surface of each element chamber 32. A light measuring head of the measuring means measures the reflected optical density of the dry analysis elements 11 through this opening. The rotary member 31 of the incubator 3 is rotationally driven reciprocally, and the optical density of color reactions of dry analysis elements 11 within the element chambers 32 are sequentially measured by the light measuring head, which is provided under a predetermined rotational position. After the series of measurements, the rotary member 31 is rotationally driven in the opposite direction to return to a standard position, and is controlled to be rotationally driven reciprocally within a predetermined angular range to perform a next series of measurements.

In the case that ion activity is to be measured, three pairs of openings for measuring ion activity are formed in the sides of the element chambers 32. The three pairs of electrical potential measuring probes of the electrical potential difference measuring means are provided so as to be capable of contacting the ion selecting electrodes of the dry analysis elements 11. Electrical potential differences corresponding to differences in ion activity of a sample and a reference solution will be generated in a dry analysis element 11 having the sample spotted through one liquid supply aperture and the reference solution spotted through the other liquid supply aperture. Therefore, the ion activity within the sample can be measured by the electrical potential measuring probes measuring the generated electrical potential differences from each ion selecting electrode pair.

Next, the blood filtering unit 6 (FIG. 1) separates plasma from blood and suctions the plasma via a holder 16 having a filter formed by glass fibers mounted to the upper end opening of the sample container 10 (blood collecting tube) held by the sample tray 2. A cup portion at the upper end of the holder 16 holds the filtered plasma. A suction cup portion 62 that attaches to the holder 16 by suction is provided at the lower side of the leading end of a suctioning section 61 that generates negative pressure. The suction cup portion 62 is connected to a pump (now shown). The suctioning section 61 is supported to be raised and lowered with respect to a support column 63 by a raising/lowering mechanism (not shown). Separation of plasma from blood is performed by lowering the suctioning section 61 to come into close contact with the holder of the sample container 10. Then, the pump is driven to suction whole blood within the sample container 10 such that the whole blood is filtered by the filter and plasma is supplied to the cup portion. Thereafter, the suctioning section 61 is raised to return to its original position, and filtration is completed.

FIG. 1 illustrates the outer appearance of the biochemical analysis apparatus 1 in which the mechanisms described above are provide within the apparatus main body 17 (casing). An operating panel 18 equipped with a display window 18a is provided above the incubator 3. The sample tray 2 and the spotting nozzle unit 5 are covered by an openable transparent protective cover 19. Loading and replacement of the biochemical analysis cartridges 7 with respect to the sample tray 2 are performed by opening (removing) the protective cover 19.

Next, the operation of the biochemical analysis apparatus 1 will be described. First, before executing analysis, sample containers 10 that contain samples therein and types of dry analysis elements 11 corresponding to measurement items for the samples are loaded into the biochemical analysis cartridges 7 outside the apparatus. That is, dry analysis elements 11 corresponding to measurement items for the samples are prepared, the packaging of the individually packaged dry analysis elements 11 are torn, the ends of the dry analysis elements 11 are held to remove them from the packaging, then the dry analysis elements 11 are inserted into the element housing chambers 71 of the biochemical analysis cartridges 7 via the element exit openings thereof to load the dry analysis elements 11 therein.

The sample containers 10 and the biochemical analysis cartridges 7 that have stored therein the dry analysis elements 11 corresponding to the samples in the sample containers 10 are loaded onto the sample tray 2 by removing the protective cover 19. In the case that there are a plurality of samples, a biochemical analysis cartridge 7 corresponding to each sample is loaded. In addition, the nozzle tips 12, the mixing cups 13, the diluent containers 14 and the reference solution containers 15 are also loaded onto the sample tray 2 as expendable goods. In the format illustrated in FIG. 2, the expendable goods cartridges 8 are loaded onto the sample tray 2.

Next, the biochemical analysis apparatus 1 reads out all of the calibration curve data stored in the memory element 75 using the calibration curve data readout section 23 at the loaded positions of the biochemical analysis cartridges 7.

Thereafter, analysis operations are initiated. Note that in the case that an emergency sample is to be examined, measurement operations are ceased temporarily, and a biochemical analysis cartridge 7 corresponding to the emergency sample is loaded to an unoccupied portion or by replacing one of the biochemical analysis cartridges 7 loaded on the sample tray 2.

First, the blood filtering unit 6 obtains a plasma component by filtering whole blood within a sample container 10. Next, the sample tray 2 is rotated to cause a biochemical analysis cartridge 7 corresponding to a sample to be measured to stop at a position corresponding to the spotting section 4. The element conveying member 91 of the conveying means 9 conveys a dry analysis element 11 from the biochemical analysis cartridge 7 to the spotting section 4. During the conveyance, the bar code reader 24 reads the bar code provided on the dry analysis element 11, and the examination item of the dry analysis element 11 is detected.

Next, the warning means judges whether the calibration curve data specified by the identifying data read out by the identifying data readout section 24 is within an effective period, based on the calibration curve data read out by the calibration curve data readout section 23. That is, the warning means refers to the calibration curve data read out by the calibration curve data readout section based on to judge whether the dry analysis element 11 is past its effective lifetime correlated with a lot number specified by the bar code of the dry analysis element 11. If it is judged that the dry analysis element 11 is past its effective lifetime, the warning means interrupts the examination using the dry analysis element for which calibration curve data does not exist. The warning means issues an audio or visual warning such as a buzzer or a blinking lamp, and displays a warning in the display window 18a of the operating panel 18. For example, a user may remove the dry analysis element 11 that the warning was issued for from the biochemical analysis apparatus 1 based on the warning, and continue examinations using other dry analysis elements.

In addition, the warning issued by the warning means may be any warning as long as it is recognizable by users. For example, the warning is not limited to those that use sound or light, and may alternatively be a warning displayed on an operating screen of an apparatus that utilizes the biochemical analysis cartridge or on a display of a computer connected to the apparatus that utilizes the biochemical analysis cartridge.

Note that any known method may be applied by the warning means, as long as it is a method that can judge whether the calibration curve data specified by the obtained identifying data, based on the calibration curve data read out by the calibration curve data readout section 23.

Next, in the case that the read out examination item is measurement of ion activity, different processes are performed according to cases such as those in which dilution is required. In the case that the read out examination item is a color reaction measurement, the sample tray 2 is rotated to move a nozzle tip 12 under a spotting nozzle 53 and the nozzle tip 12 is mounted onto the spotting nozzle 53. Next, the sample container 10 is moved, the spotting nozzle 53 is lowered to suction a sample into the nozzle tip 12, the spotting nozzle 53 is moved to the spotting section 4, and the sample is spotted onto the dry analysis element 11.

Then, the dry analysis element 11 on which the sample has been spotted is inserted into the incubator 3. When the dry analysis element 11 is inserted, the element chamber 32 of the incubator 3 is rotated such that the inserted dry analysis element 1 is moved to a position that faces the light measuring head. Measurement of the reflected optical density of the dry analysis element 11 is performed by the light measuring head after a predetermined amount of time. After measurement is complete, the element chambers 32 are returned to the positions thereof prior to insertion. Thereafter, the element conveying member 91 pushes the dry analysis element 11 for which measurement has been completed toward the center to discard the dry analysis element 11. Finally, the results of measurement are output, the used nozzle tip 12 is removed from the nozzle 53, and the process is completed.

In the case that the examination item is that requires dilution, for example, a case in which the concentration of blood is too great to enable accurate examination, the sample tray 2 is moved to mount a nozzle tip 12 onto a spotting nozzle 53. Next, the sample tray is moved, the nozzle 53 is lowered into a sample, and the sample is suctioned into the nozzle tip 12. The sample tray 2 is moved to dispense the suctioned sample into a mixing cup 13 from the nozzle tip 12, and then the used nozzle tip 12 is removed. Then, a new nozzle tip 12 is mounted onto the spotting nozzle 53, and diluent is suctioned into the nozzle tip 12 from a diluent container 14. The suctioned diluent is expelled tip 12 into the mixing cup 13 from the nozzle tip 12. Then, the nozzle tip 12 is inserted into the mixing cup 13, and suctioning and expulsion are repeated to perform mixing. After the mixing is performed, the diluted sample is suctioned in to the nozzle tip 12, the spotting nozzle 53 which has suctioned the diluted sample is moved to the spotting section 4, and the sample is spotted onto the dry analysis element 11. Thereafter, light measurement, discarding of the element, output of the results, and discarding of the tip are performed in the same manner as described above, and the process is completed.

Next, a case will be described in which the examination item is measurement of ion activity. Note that in the case that ion activity is to be measured, an electrolytic dry analysis element 11 is conveyed. First, a nozzle tip 12 is mounted onto one of the spotting nozzle 53, and suctions a sample. Next, a nozzle tip 12 is mounted onto the other of the spotting nozzles 53, and suctions a reference solution from a reference solution container. Then, the one spotting nozzle 53 spots the sample into a first liquid supply aperture of the dry analysis element 11, and the other spotting nozzle 53 spots the reference solution into a second liquid supply aperture of the dry analysis element 11.

Then, the dry analysis element 11 which has been spotted with the sample and the reference solution is inserted into an element chamber 32 of the incubator 3 from the spotting section 4. When the dry analysis element 11 is inserted into the incubator 3, measurement of ion activity is performed by the electrical potential difference measuring means. After measurement is complete, the element conveying member 91 pushes the dry analysis element 11 for which measurement has been completed toward the discarding opening 33 at the center of the incubator 3 to discard the dry analysis element 11. Finally, the results of measurement are output, both of the used nozzle tips 12 are removed from the nozzle 53 and discarded, and the process is completed.

In the embodiment described above, the biochemical analysis cartridge houses a plurality of dry analysis elements 11 corresponding to a plurality of measurement items necessary to measure a sample and supplies the dry analysis elements 11 to the biochemical analysis apparatus 1, and comprises the memory element 75 that stores calibration curve data for all dry analysis elements 11 which are within their effective lifetimes at the time of manufacture or shipment of the biochemical analysis cartridge 7. Therefore, the calibration curve data to be stored in the memory element 75 provided on the biochemical analysis cartridge 7 can be easily specified. In addition, calibration data for all dry analysis elements 11 which are within their effective lifetimes at the time of manufacture or shipment of the biochemical analysis cartridge can be supplied to the biochemical analysis apparatus 1. Therefore, necessary calibration curve data can be easily and positively supplied. As a result, the burden on users is lessened, and the efficiency of measurement operations can be improved.

In addition, the memory element 75 stores calibration curve data for all dry analysis elements “which are within their effective lifetimes at the time of manufacture or shipment of the biochemical analysis cartridge 7”. Therefore, the calibration curve data stored in the memory element and supplied to the biochemical analysis apparatus can be those regarding dry analysis elements which are manufactured within a period of time comparatively close to the time when the dry analysis element is utilized.

The biochemical analysis cartridge 7 of the present embodiment obtains a significant advantageous effect that necessary calibration curve data can be supplied easily and positively to biochemical analysis apparatuses which are not connected to a network.

The memory element 75 is provided at a position at which the biochemical analysis apparatus 1 is capable of reading out data therefrom when the cartridge 7 is loaded into the biochemical analysis apparatus 1. Therefore, the calibration curve data stored in the memory element 75 can be read out by the biochemical analysis apparatus 1 when the biochemical analysis cartridge 7 is loaded. The need to update the calibration curve data in a separate process is obviated, and the calibration curve data are easily and positively updated by the biochemical analysis apparatus.

The biochemical analysis apparatus 1 comprises the calibration curve data readout section 23 that reads out the calibration curve data stored in the memory element 75 of the biochemical cartridge 7 of the present invention; the identifying data readout section 24 that reads out the identifying data of the dry analysis elements 11 loaded in the biochemical analysis cartridge 7; and the warning section that issues a warning in the case that the calibration curve data specified by the identifying data read out by the identifying data readout section 24 is not within an effective period, based on the calibration curve data read out by the calibration curve data readout section 23. Therefore, users can be notified of erroneous use of dry analysis elements of which the effective lifetimes have elapsed, and accurate lifetime management of dry analysis elements can be assisted.

In addition, the memory element 75 of the present embodiment has the latest calibration curve data and effective periods at the time of shipment of the biochemical analysis cartridge 7 stored or updated therein. Therefore, necessary calibration curve data can be supplied more accurately, simply, and positively. Further, warnings can be issued more accurately by the warning means because the latest calibration curve data and the effective periods are stored in the memory element 75. As a result, more accurate lifetime management of dry analysis elements can be assisted.

What is claimed is:

1. A biochemical analysis cartridge that houses a plurality of dry analysis elements corresponding to a plurality of measurement items necessary to measure a sample and supplies the dry analysis elements to a biochemical analysis apparatus, wherein:
the biochemical analysis cartridge comprises a memory element that stores calibration curve data for all dry analysis elements which are within their effective lifetimes at the time of manufacture or shipment of the biochemical analysis cartridge.

2. A biochemical analysis cartridge as defined in claim 1, wherein:
the memory element is provided at a position at which the biochemical analysis apparatus is capable of reading out data therefrom.

3. A biochemical analysis apparatus, comprising:
a calibration curve data readout section that reads out calibration curve data stored in the memory element of the biochemical cartridge defined in claim 1;
an identifying data readout section that reads out identifying data of the dry analysis elements loaded in the biochemical analysis cartridge; and
a warning section that issues a warning in the case that the calibration curve data specified by the identifying data read out by the identifying data readout section is not within an effective period, based on the calibration curve data read out by the calibration curve data readout section.
